(19) United States
(12) Patent Application Publication
(10) Pub. No.: US 2026/0310624 A1
(43) Pub. Date: Oct. 8, 2026

(54) PACKING OF TRANSACTION LAYER FLITS INTO DATA LAYER FLITS FOR TRANSMISSION OVER INTERCONNECT FABRIC

(71) Applicants: Advanced Micro Devices, Inc., Santa Clara, CA (US); ATI Technologies ULC, Markham (CA)

(72) Inventors: Michael Tresidder, Willow City, TX (US); David Alan Brown, Ontario (CA); Remco van Steeden, Vancouver (CA)

(73) Assignees: Advanced Micro Devices, Inc., Santa Clara, CA (US); ATI Technologies ULC, Markham (CA)

(21) Appl. No.: 19/396,156

(22) Filed: Nov. 20, 2025

Related U.S. Application Data
(60) Provisional application No. 63/784,874, filed on Apr. 7, 2025.

(51) Int. Cl. G06F 13/42

(52) U.S. Cl. CPC G06F 13/42

(57) ABSTRACT

Systems and devices for packaging first data flits into second data flits may include at least one circuit of a first processor. In a transmit direction, the at least one circuit receives first data flits and packages the data of the first data flits into second data flits for transmission to at least one second processor over an interconnect link. In a receive direction, the at least one circuit receives a second data flit and packages the data into one or more first data flits for transmission to the first processor. The first data flit and second data flit may be a transaction layer flit and data layer flit, respectively. The second data flit may include a flit header, a cyclic redundancy check, and a plurality of segments, each segment including a segment header, an integer number of sectors, and one or more portions for storing the first data flits.

### CROSS-REFERENCE TO RELATED APPLICATIONS

The present application claims priority to and benefit of U.S. Provisional Patent Application No. 63/784,874, filed Apr. 7, 2025, and entitled “Packing of Transaction Layer Flits into Data Layer Flits for Transmission over Interconnect Fabric,” the entirety of which is herein incorporated by reference.

### BACKGROUND

Accelerators are commonly used in computing systems such as, for example, processing nodes in data centers to perform a wide range of demanding processing tasks such as, for example, computations, model inferencing, storage, and other applications. Many applications require real-time or near real-time results, which may be achieved by multiple processing nodes working together through data communication and resource sharing to perform common tasks. Accordingly, providing high-speed, low-latency communications over an interconnect fabric between accelerators plays a critical role in capitalizing on the full potential of these systems.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 illustrates a block diagram of an exemplary system, according to some embodiments.

FIG. 2 illustrates a diagram of an exemplary system, according to some embodiments.

FIG. 3 illustrates a block diagram of an exemplary system, according to some embodiments.

FIG. 4 is a block diagram of an exemplary computer system configured to implement the techniques described herein, according to some embodiments.

FIG. 5 illustrates an example diagram of a portion of an exemplary communication system, according to some embodiments.

FIG. 6 illustrates an exemplary datagram, according to some embodiments.

FIGS. 7-9 illustrate exemplary diagrams of portions of datagram of FIG. 6 being packed with TL flits, according to some embodiments.

FIG. 10 illustrates a flow diagram of an exemplary method, according to some embodiments.

### DETAILED DESCRIPTION

Described herein are various examples of systems and methods for encoding data and messages into suitable formats for transmission between link partners over a physical link in accordance with a protocol, which may in some embodiments be implemented to process data during transmission between the link partners. A link partner may, in some examples, include circuitry to convert data between transaction layer (TL) flits and data link layer (DL) flit during data transmission between the link partners. The link partners may, in some examples, include chiplets arranged at a CPU core of a processing node or accelerator. The link partners may, in some examples, include a host computing system and at least one other host computing system communicatively coupled to each other over a physical link for transmission of datagrams therebetween in accordance with a protocol of this disclosure. In the transmit direction, data and messages of transaction layer (TL) flits may in some embodiments be packed into data link layer (DL) flits. In the receive direction, data and messages may in some embodiments be removed from DL flits and packed into TL flits. The TL flits may have a different size and organization from the DL flits. Accordingly, the flit packing between TL flits and DL flits may include encoding the data into the suitable format based on the flit type, so that they have a suitable size and organization for processing and transmission at their respective layers, which may be provided for reliable and efficient data transfer and processing when sending and receiving data and messages between the link partners. For example, the host computing system and the at least one other host computing system may be processing nodes in one or more servers of a data center in communication with each other over a physical link of an interconnect fabric to perform resource sharing and data transmission while performing a processing operation.

The packing of TL flits into DL flits, or vice versa, in accordance with some techniques described herein may improve the efficiency and latency in processing and transmission of data between link partners. The sector number and byte number within each sector of the DL flit may be improved to reduce multiplexing of bytes, to reduce combinational delays, and to achieve higher clock speeds. In the transmit direction, the packing of TL flits into DL flits may be performed on the fly to reduce latency and operate at a high clock rate. Flit packing may support multiple logical flows, such that DL messages and TL flits may be packed together into segments of the DL flits. Each segment may include a segment header that describes its contents. Because TL flits may be from different logical sources, the segment header may include information for the logical source to enable the at least one other host computing system at a receiver side of the link to route the contents. TL flits may have a floating assignment when packed into DL flits such that a TL flit may start on any sector of a plurality of sectors of a segment of the DL flit such that all available bandwidth of the DL flit may be utilized to improve throughout.

Among those benefits and improvements that have been disclosed, other objects and advantages of this disclosure will become apparent from the following description taken in conjunction with the accompanying figures. Detailed embodiments are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

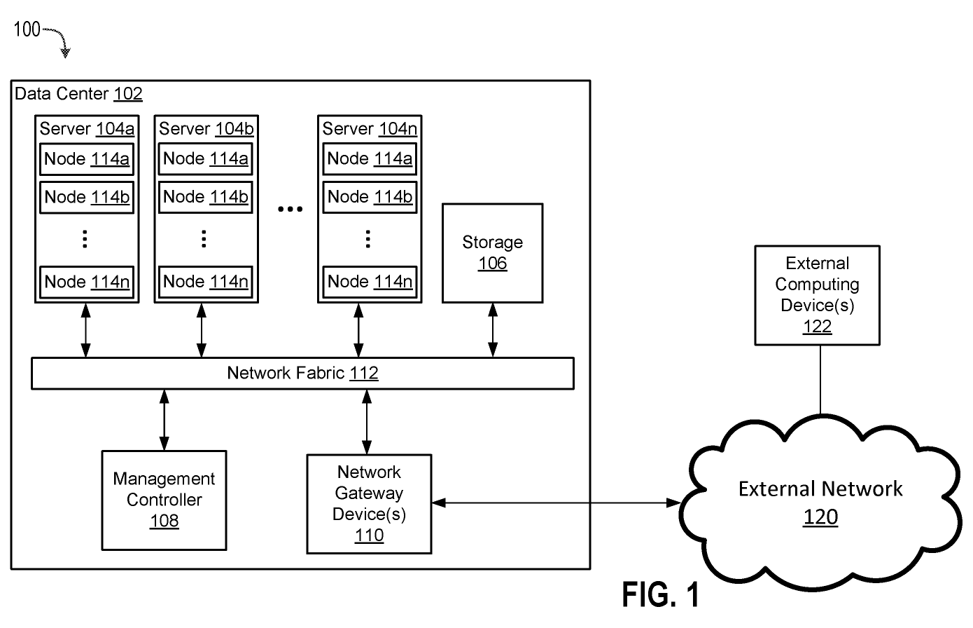

FIG. 1 illustrates a block diagram of an exemplary system 100, according to some embodiments. The system 100 may be configured to implement some techniques described herein, although other systems are possible.

Referring to FIG. 1, the system 100 may include a data center 102. The data center 102 may be communicatively connected to an external network 120. The data center 102 may, for example, receive processing requests from external computing device(s) 122 via the external network 120. The data center 102 may be utilized to perform any of a plurality of processing or rendering tasks based on one or more data sets using at least some portion of a processing and rendering resources of data center 102. For example, a user of an external computing device 122 may send a processing request to data center 102 via external network 120, and the data center 102 may utilize one or more of the processing resources of data center 102 to fulfill the user request. It should be appreciated that FIG. 1 is intended neither to be a depiction of necessary components for a data center or components thereof to operate in accordance with the principles described herein, nor a comprehensive depiction. The system 100 can include additional components, omit one or more of the described components, multiple instances of a component even if only one instance is shown in FIG. 1), and/or can be organized in other suitable manners.

In some examples, the data center 102 may include a plurality of servers 104, storage device(s) 106, management controller 108, and a network gateway device(s) 110. Each of the plurality of servers 104, storage device(s) 106, management controller 108, and network gateway device(s) 110 may be communicatively coupled with one or more other components of the data center 102 over a network fabric 112.

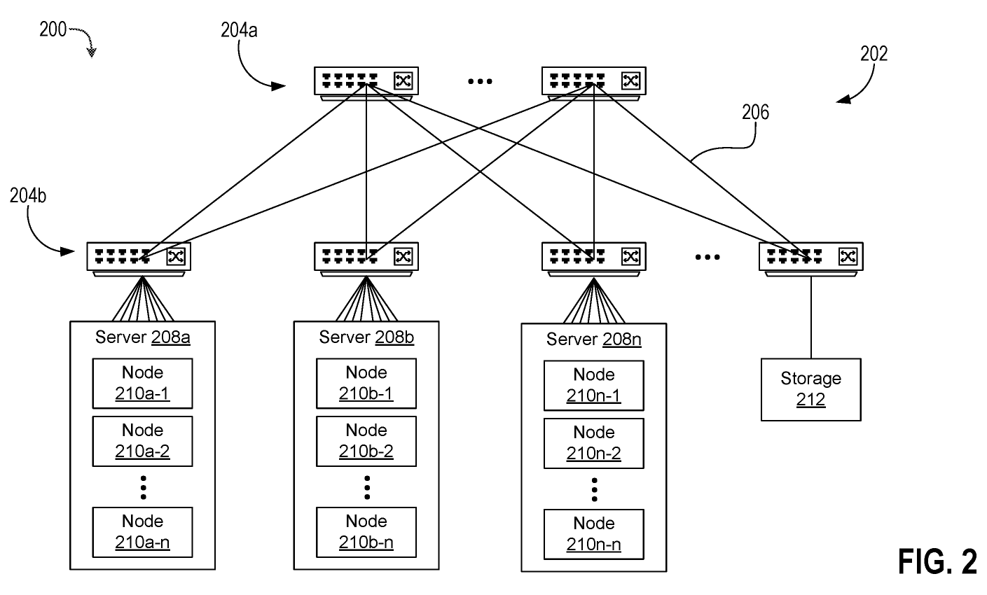

The plurality of servers 104 may include servers 104a, 104b, through 104n. Each server 104a, 104b, through 104n may include a plurality of processing nodes 114, each of the plurality of processing nodes 114 including one or more processing resources for performing processing or rendering tasks, as will be further described herein. While the examples of FIGS. 1 and 2 illustrate servers 104 that include processing nodes 114, in other embodiments each processing nodes 114 may include processing and storage resources and may be directly connected to network fabric 112, such that there may not be any element considered to be a server 104 or such that each processing node 114 may be considered a separate server 104.

The storage device(s) 106 may include a variety of computer-readable media for storing data, programs, instructions, etc. for use by the plurality of processing nodes 114 of the plurality of servers 104. For example, storage device(s) 106 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the plurality of processing nodes 114. The storage device(s) 106 can include computer-storage media in the form of volatile and/or nonvolatile memory. The storage device(s) 106 may be removable, non-removable, or any combination thereof. For example, storage device(s) 106 can include hardware devices such as hard drives, solid-state memory, optical-disc drives, and the like.

The management controller 108 may be connected to each of the plurality of servers 104, storage device(s) 106, network gateway device(s) 110. Each of the plurality of servers 104 (shown as servers 104a, 104b, through 104n) may include a plurality of processing nodes 114 (shown as nodes 114a, 114b, through 114n). The management controller 108 may include a combination of hardware, software and firmware to assist in orchestration of processing operations using the plurality of processing nodes 114 at each of the plurality of servers 104, which may include controlling storage, communications, timing, frequency, etc. within the data center 102 and/or between parts of the plurality of servers 104 and other systems (e.g., external client devices).

The network gateway device(s) 110 may communicatively connect data center 102 to external network 120, which may be used to enable external computing device(s) 122 to send processing requests to data center 102, and to receive data from data center 102 responsive to the request via external network 120. For example, network gateway device(s) 110 may receive a processing request from a user of an external computing device 122 via external network 120, and the network gateway device(s) 110 may transmit the request to management controller 108 to orchestrate fulfillment of the request using one or more of the plurality of processing nodes 114 of the plurality of servers 104 in accordance with the user request.

FIG. 2 illustrates a diagram of an exemplary system 200, according to some embodiments. The system 200 may be configured to implement some techniques described herein, although other systems are possible. System 200 may be implemented with any combination of components and/or subsystems of system 100.

It should be appreciated that FIG. 2 is intended neither to be a depiction of necessary components for a data center or components thereof to operate in accordance with the principles described herein, nor a comprehensive depiction. The system 200 can include additional components, omit one or more of the described components, multiple instances of a component even if only one instance is shown in FIG. 2), and/or can be organized in other suitable manners.

In some examples, system 200 may include a network fabric 202 coupled to one or more components including a plurality of servers 208 (shown as servers 208a, 208b, through 208n). The one or more other components may include any of the components or sub-systems of system 100. Each of the plurality of servers 208 may include a plurality of nodes 210 for fulfilling processing tasks received from, for example, management controller 108 of FIG. 1. For example, referring to FIG. 2, server 208a may include nodes 210a-1, node 210a-2, through node 210a-n. For example, the one or more other components of system 200 may include storage 212, which may be connected to network fabric 202 to enable the plurality of servers 208 and the plurality of processing nodes 210 of each of the plurality of servers 208 to store and retrieve data from storage 212.

The network fabric 202 may include a plurality of switches 204 interconnected together via one or more interconnect links 206 such that each switch 204 of the plurality of switches 204 may be connected to one or more other components of system 200. In some examples, the plurality of switches 204 of network fabric 202 may include spine switches 204a and leaf switches 204b. The spine switches 204a may be used to interconnect one or more leaf switches 204b. The leaf switches 204b may interconnect one or more servers to the spine switches 204a. The leaf switches 204b may serve as an access switch that aggregates data traffic from servers and forwards the data to the spine switches 204a for transmission to its intended destination. The leaf switches 204b may be referred to as top-of-rack switches, and which may be used to connect to the plurality of processing nodes 210 of a given server 208 to enable data transmission and resource sharing between the plurality of processing nodes 210 of the given server 208 and/or data transmission and resource sharing between nodes 210 of respective servers of the plurality of servers 208.

The interconnect links 206 be used for serialized data transmission between at least two components of system 200 over one or more lanes at a defined serial rate. In some examples, one or more of the interconnect links 206 may be defined in accordance with 200 Gigabit communication standard. In some embodiments the one or more of the interconnect links 206 may be defined for 1, 2, or 4 serial lanes capable of running at a serial rate of 212.5 Gbps. For example, the interconnect links 206 may be designed in accordance with 200GBASE-KR1/CR1, 400GBASE-KR2/CR2, and/or 800GBASE-KR4/CR4 standards. In some examples, one or more of the interconnect links 206 may be defined in accordance with 100 Gigabit communication standard. In some embodiments the one or more of the interconnect links 206 may be defined for 1, 2, or 4 serial lanes capable of running at a serial rate of 212.5 Gbps. For example, the interconnect links 206 may be designed in accordance with 100GBASE-KR1/CR1, 200GBASE-KR2/CR2, 400GBASE-KR4/CR4 standards.

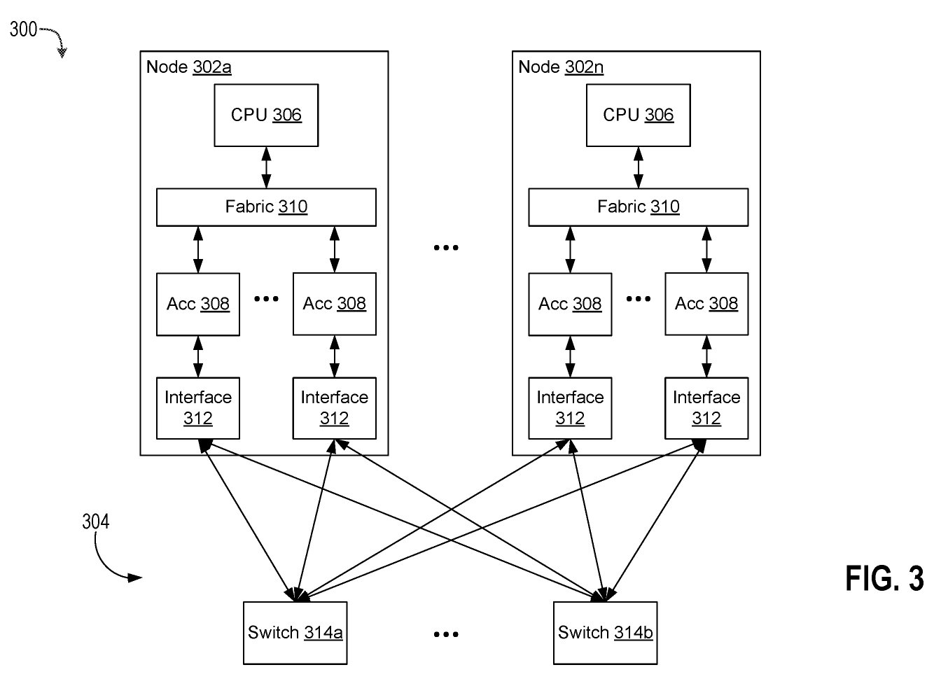

FIG. 3 illustrates a block diagram of an exemplary system 300, according to some embodiments. The system 300 may be configured to implement the techniques described herein, although others are possible. System 300 may be implemented with any combination of components and/or subsystems of system 100 and system 200.

System 300 may include one or more processing nodes 302 (shown as processing node 302a through processing node 302n). Each processing node 302 may be coupled to one or more other components of system 300 over an interconnect fabric 304. In some examples, each processing node 302 may be connected to one or more other processing nodes 302 over interconnect fabric 304 for data transmission and resource sharing purposes. In some examples, each processing nodes 302 may be selectively utilized to perform a processing or rendering operation either discretely or in parallel with one or more other processing nodes 302 in accordance with some orchestration scheme as determined by, for example, management controller 108 of FIG. 1.

In some examples, processing node 302 may include a host central processing unit (CPU) 306, a plurality of accelerators 308, one or more of the components may be communicatively attached through host fabric 310 (or other connection circuitry). In some examples, the CPU 306, plurality of accelerators 308, and data fabric 310 may be coupled to (e.g., mounted on) a printed circuit board (e.g., motherboard).

The CPU 306 may be configured to process data and execute instructions of an operating system and/or instructions (e.g., program code) of one or more applications. In some examples, the functionality of the program code may be implemented by one or more of the CPU 306, one or more processor chiplets of a CPU 306, and/or one or more cores of a processor chiplet of a CPU 306. The data and instructions can be stored on a memory (not shown) coupled to CPU 306. The data and instructions can comprise computer-executable instructions implementing any suitable functionality.

In some examples, as part of executing a given software application, the CPU 306 launches rendering tasks to be performed on the plurality of accelerators 308. It should be appreciated that although FIG. 3 shows plurality of accelerators 308, the processing node 302 may include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 310 connects CPU 306 and plurality of accelerators 308, and other components within the processing node 302. The host fabric 310 may include any type of communication fabric, bus, and/or other control and interface logic for facilitating the communication of data between various components of the processing node 302. For example, the host fabric 310 may include data paths, switches, routers, and other logic used to communicate data among the various components. In some embodiments, the host fabric 310 may be bus-based, including shared bus configurations, crossbar configurations, and hierarchical buses with bridges. host fabric 310 may also be packet-based, and can be hierarchical with bridges, crossbar, point-to-point, or other interconnects.

In some examples, each processing node 302 may further include one or more interface devices 312. The one or more interface devices 312 may be used to communicatively connect the accelerators 308 of a processing node 302 to one or more other accelerators 308 of another processing node 302 for data transmission and resource sharing purposes over interconnect fabric 304. For example, one or more accelerators 308 of processing node 302a may be connected to the one or more accelerators 308 of processing node 302n over the interconnect fabric 304 for data transmission and resource sharing. For example, the one or more interface devices 312 may be network interface cards (“NICs”) for connecting the plurality of accelerators 308 of processing node 302 to the interconnect fabric 304 and one or more other components of the system 300. In some examples, interconnect fabric 304 may include a plurality of switches including at least switch 314a and 314b, and one or more of the plurality of accelerators 308 of processing node 302a may be communication connected to one or more of the plurality of accelerators 308 of processing node 302n through at least one of switch 314a and switch 314b of interconnect fabric 304.

It should be appreciated that system 300 of FIG. 3 may further include one or more interface devices (e.g., NICs), and each CPU 306 may be connected to a respective interface device to enable front-end communication between the processing node 302 and one or more other components of system 300 over the interconnect fabric 304. For example, management controller 108 may send processing instructions to CPU 306 through the respective interface device.

It should be appreciated that FIG. 3 is intended neither to be a depiction of necessary components for a processing node or components thereof to operate in accordance with the principles described herein, nor a comprehensive depiction. The system 300 can include additional components, omit one or more of the described components, multiple instances of a component even if only one instance is shown in FIG. 3, and/or can be organized in other suitable manners.

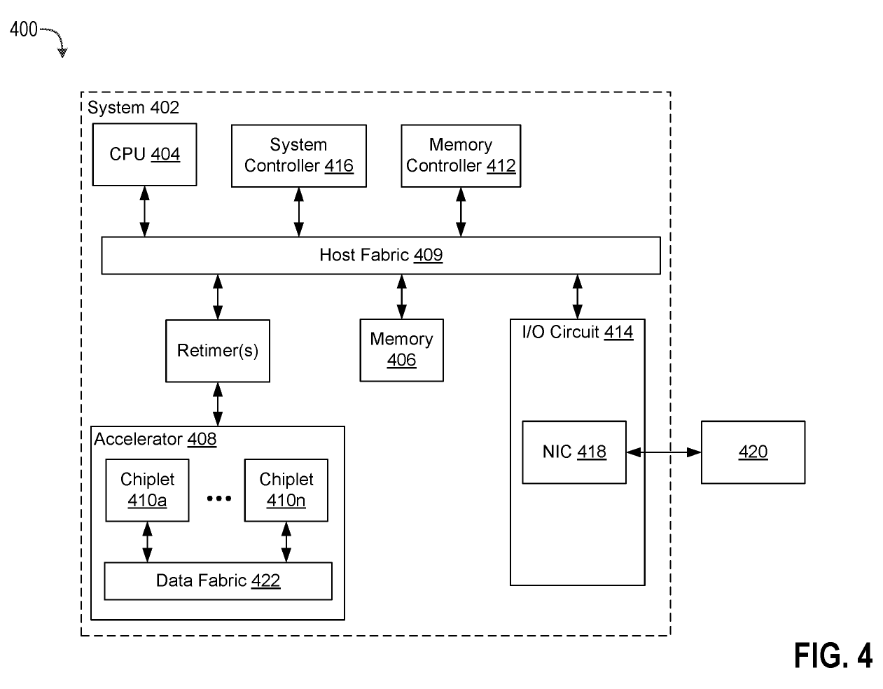

FIG. 4 is a block diagram of an exemplary computer system 400, according to some embodiments. The computer system 400 may be configured to implement some techniques described herein, although other systems are possible. Computer system 400 may be implemented with any combination of components and/or subsystems of system 100, system 200, and system 300.

The computer system 400 may be or otherwise be included within, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. It should be appreciated that FIG. 4 is intended neither to be a depiction of necessary components for a computer system or device to operate in accordance with the principles described herein, nor a comprehensive depiction. The computer system 400 can include additional components, omit one or more of the described components, multiple instances of a component even if only one instance is shown in FIG. 4), and/or can be organized in other suitable manners.

In some examples, the computer system 400 may be a processing node, which may include a central processing unit (CPU) 404, a system memory 406, and an accelerator 408, all communicatively attached through host fabric 409 (or other connection circuitry). In some examples, the CPU 404, system memory 406, accelerator 408, and host fabric 409 are coupled to (e.g., mounted on) a printed circuit board (e.g., motherboard).

The CPU 404 can include any combination of processing units, for example, one or more processor chiplets, each including one or more cores. In some examples, the processor chiplets (or other processing units) can communicate with each other via interconnects routed through or on a package substrate. The CPU 404 is configured to process data and execute instructions of an operating system and/or instructions (e.g., program code) of one or more applications. In some examples, the functionality of the program code may be implemented by one or more of the CPU 404, one or more processor chiplets of a CPU 404, one or more cores of a processor chiplet, and/or the accelerator 408. The data and instructions can be stored on system memory 406 and/or memory (not shown). The data and instructions stored on any of the computer-readable storage media (e.g., system memory 406, registers, internal or external of the CPU 404, caches of the accelerator 408, etc.) can comprise computer-executable instructions implementing any suitable functionality.

The system memory 406 can include a variety of computer-readable media for storing data, programs, instructions, etc. for use by the computer system 402. For example, system memory 406 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the CPU 404 and/or the accelerator 408. The system memory 406 can include computer-storage media in the form of volatile and/or nonvolatile memory. The system memory 406 may be removable, non-removable, or any combination thereof. For example, system memory 406 can include hardware devices such as hard drives, solid-state memory, optical-disc drives, and the like.

In some examples, as part of executing a given software application, the CPU 404 launches rendering tasks to be performed on the accelerator 408. The accelerator 408 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 409 connects CPU 404, system memory 406 (directly of via one or more memory controllers 412), accelerator 408, I/O circuitry 414, and other components within the system 402. The host fabric 409, can include any type of communication fabric, bus, and/or other control and interface logic for facilitating the communication of data between various components of the computer system 402. For example, the host fabric 409 can include data paths, switches, routers, and other logic used to communicate data among the various components. In some embodiments, the host fabric 409 can be bus-based, including shared bus configurations, crossbar configurations, and hierarchical buses with bridges. Host fabric 409 can also be packet-based, and can be hierarchical with bridges, crossbar, point-to-point, or other interconnects. The host fabric 409 is configured to route memory access requests and memory responses between any memory accessing components and/or the one or more memory controllers 412. The host fabric 409 can also include a system memory map (e.g., defined by BIOS) for determining destinations of memory accesses based on the system configuration.

In some examples, the computer system 402 includes a system management circuit 416. Each of the CPU 404, the system memory 406 (directly of via one or more memory controllers 412), the accelerator 408, host fabric 409, and the I/O circuitry 414 can be bidirectionally connected to a system management circuit 416 (or power management controller), which forms a control fabric and is configured to provide memory access requests to host fabric 409. The system management circuit 416 can include a combination of hardware, software, and firmware to assist in controlling storage, communications, timing, frequency, etc. within the computer system 402 and/or between parts of the computer system 402 and other systems (e.g., client devices).

For example, the system management circuit 416 manages power-up sequencing of the various processors and includes one or more clock sources (e.g., a phase locked loop (PLL)), to provide clock signals for each of the components of the computer system 402. The system management circuit 416 also manages power for the various processors and other functional blocks and may receive measured power consumption values from CPU 404 and accelerator 408 to determine appropriate power states. The computer system 402 also implements various system monitoring and power saving functions, for example, thermal monitoring. The computer system 402 can assist in tracking mitigating action based on such monitoring. For example, if the computer system 402 becomes hot, then system management circuit 416 can reduce the frequency and voltage of CPU 404 and/or accelerator 408 or shut down the computer system 402 entirely. In some examples, the system management circuit 416 can control and/or trigger proactive and/or reactive mitigation actions to be taken based on monitored criteria. For example, the system management circuit 416 initiate proactive dynamic workload control and/or reactive “big hammer” actions such as drastic clock frequency reduction.

The one or more memory controllers 412 are configured to control the flow of data to and from the system memory 406. For example, the memory controller(s) 412 can handle the reading and writing of data to and from the system memory 406, schedule access to the system memory 406 to optimize bandwidth and latency, detect and correct errors in data stored in memory, translate logical addresses into physical addresses, adjust the use of available memory bandwidth to improve performance, among other tasks.

In some examples, the I/O circuitry 414 may be configured to physically connect and communicate with one or more other components. In some examples, the I/O circuitry 414 may include a network interface card (NIC) 418 to connect the computer system 402 to an interconnect fabric 420 of a network system such as, for example and without limitation, system 100 of FIG. 1. In some examples, the NIC 418 may be a standalone card separate from the I/O circuitry 414.

In some examples, the I/O circuitry 414 may be configured to physically connect to peripheral devices and control the flow of data to and from the system memory 406 and/or storage. Some non-limiting examples of an input device can include a mouse, keyboard, scanner, video game controller, microphone, webcam, etc. Some non-limiting examples of an output device can include a display, printer, speakers, headphones, earbuds, etc. The I/O circuitry 414 can include any suitable type of peripheral connector(s), including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc. In some examples, portions of the I/O circuitry 414 can be integrated into a motherboard and/or motherboard chipset (e.g., I/O circuitry 414) of the computer system 402.

As described above, computer system 402 may have one or more components and peripherals, including input and output devices. These devices may be used, among other things, to present a user interface. Examples of output devices that can be used to provide a user interface include display screens for visual presentation.

In some examples, the accelerator 408 may include any combination of processing units, for example, one or more processor chiplets, each including one or more cores. In some examples, the processor chiplets (or other processing units) can communicate with each other via a data fabric 422 comprising interconnects internally routed between each of the chiplets 410a through 410n of accelerator 408. The interconnects may in some embodiments be routed through or on a package substrate to connect the chiplets 410. The accelerator 408 may be configured to process data and execute instructions of CPU 404 and/or instructions (e.g., program code) of one or more applications. In some examples, the functionality of the program code may be implemented by one or more of the accelerator 408, one or more processor chiplets of accelerator 408, one or more cores of a processor chiplet 410, and/or the CPU 404. The data and instructions may be stored on system memory 406 and/or memory (not shown). The data and instructions stored on any of the computer-readable storage media (e.g., system memory 406, registers, internal or external of the CPU 404, caches of the processing unit 410, etc.) can comprise computer-executable instructions implementing any suitable functionality.

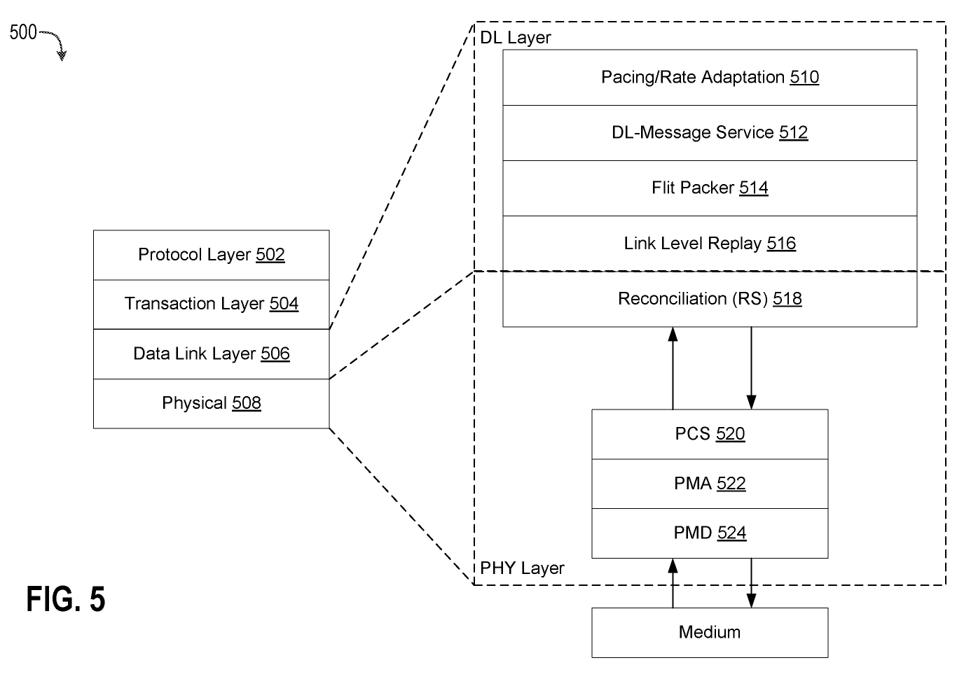

FIG. 5 illustrates an example diagram of a portion of an exemplary communication system 500, according to some embodiments. The communication system 500 may be configured to implement some techniques described herein, although other systems are possible. Communication system 500 may be implemented with any combination of components and/or subsystems of system 100, system 200, system 300, and computer system 400.

The communication system 500 described herein may be configured to facilitate packing transaction layer flits into data link layer flits for transmission between processing units and transmission over a physical link. Communication system 500 may be structured in accordance with a protocol, which may in some embodiments include one or more layers, and each layer may include one or more sub-layers, to provide robust and efficient processing data exchange capabilities between link partners with improved latency. The communication system 500 may include in some examples a data link layer for packing transaction layer flits into data link layer flits and a physical layer for a physical transmission over a medium such as, for example, interconnect link 420 of FIG. 4 and vice versa.

In some examples, system architecture of communication system 500 may include a protocol layer (PL) 502, a transaction layer (TL) 504, a data link layer (DL) 506, and a physical layer (PHY) 508. Each of these layers may be responsible for specific functions that collectively enable seamless communication between link partners. The communication system 500 may carry messages between a sender and receiver in accordance with the layers of communication system 500. In addition, the communication system 500 may be a symmetrical protocol with the same set of messages and channels supported in both transmit and receive paths. During communication, these messages may traverse through multiple functional layers of the communication system 500 in the journey between originator and transmitter.

The PL 502 may define a logical signaling interface and a protocol by which devices can exchange data and control information through a set of Request and Response messages. The PL 502 of communication system 500 may define the protocol and may expect implementations that follow this protocol will be compatible with the interconnect fabric such as, for example, network fabric 112. The communication system 500 may include built-in flexibility to allow vendors to create custom protocol messages for communication between processing units without any modification to the interconnect switches.

The TL 504 may be coupled to two PL interfaces (not shown), one interface may be communicatively coupled to an originator device via PL 502, and the other interface may be communicatively coupled to a completer device via PL 502 (not shown). The TL 504 may drive an outbound transmit (Tx) flit to the DL 506 and may receive from the DL 506 an inbound receive (Rx) flit. The channels driven into the TL 504 from both interfaces may be packaged into outbound transmit (Tx) flits, which may be transmitted to the DL 506. Similarly, the receive (Rx) flit from the DL 506 may be unpacked into Request, Read Response/Data, Orig Data, and Write Response channels for the two interfaces coupled to the TL 504, which may be transmitted to one of the originator or completer devices. Each of the outbound Tx flit and the inbound Rx flit may in some embodiments be a 64-byte flit.

The DL 506 may receive TL flits (e.g., outbound Tx flits) from the TL 504 and may package these TL flits into outbound DL flits in the transmit direction and may send them to the PHY 508. Similarly, in the receive direction the DL 506 may receive DL flits from the PHY 508 and unpacks then into TL flits (e.g., inbound Rx flits) and then sends them to the TL 504. The DL 506 may provide a control message service used for coordinating changes to the link, i.e., online/offline, and other features.

In some examples, the DL 506 may provide a mechanism for mapping the TL flits relative the DL flits to pack the TL flits into DL flits in the transmit direction and unpacking the TL flits from the DL flits in the receive direction. Referring to FIG. 5, the DL 506 may be configured to pack and unpack the TL flits at one or more sub-layers, which may include a pacing/rate adaptation sublayer 510, DL-message service sublayer 512, flit packer sublayer 514, and link level replay sublayer 516. In some examples, the packing of TL flits into DL flits and unpacking of TL flits from DL flits may be implemented at the flit packer sublayer 514, which may be used to pack the TL flits into the DL flits, as will be further described herein.

The PHY 508 may include one or more sublayers, which may in some examples include reconciliation sublayer (RS) 518, a physical coding sublayer (PCS) 520, a physical medium attachment (PMA) 522, and a physical medium dependent (PMD) 524. The PHY 508 may include an encoding block located between the RS 518 and PCS 520 for encoding and alignment of DL flits to codewords for transmission over the physical link via PCS 520, PMA 522, and PMD 524.

The PHY 508 may support one or more rates of serial communication over an interconnect link between two link partners. In some examples, the PHY 508 may support 200G serial transmission including, for example and without limitation, 200GBASE-KR1/CR1, 400GBASE-KR2/CR2, and 800GBASEKR4/ CR4. In some examples, the PHY 508 may also support 100G serial transmission including, for example and without limitation, 100 GBASE-KR1/CR1, 200 GBASE-KR2/CR2, 400 GBASE-KR4/CR4. To reduce latency at the 200G serial rates, 1-way and 2- way code word interleave modes may be supported, in addition to the standard 4-way interleave.

To improve latency each 640-byte DL Flit may be packed uniquely into a single 680-Byte code word at the PHY 508. The additional 40-bytes may be for FEC overhead and 256B/257B line coding. DL Flit to code word alignment may be achieved without implementing changes to a predefined serial communication standard, regarding alignment marker insertion and removal. That is, in some examples, the alignment markers on the wire(s) may be unchanged from IEEE 802.3 definition. Instead, the mechanism for how the alignment markers may be inserted and removed may be modified to enable a reconciliation sub-layer to decide when to start the sequences for sending the alignment markers.

In some examples, ethernet retimers may also be compatible provided they use the recovered clock for forwarding the data. Adding or removing idle codes may require FEC decode and encode and may incur a large latency penalty. In addition, this may break the DL Flit to code word association required for seamless and efficient communication over the interconnect link by communication system 500. Auto negotiation and link training may also be unchanged from 802.3 Ethernet PCS.

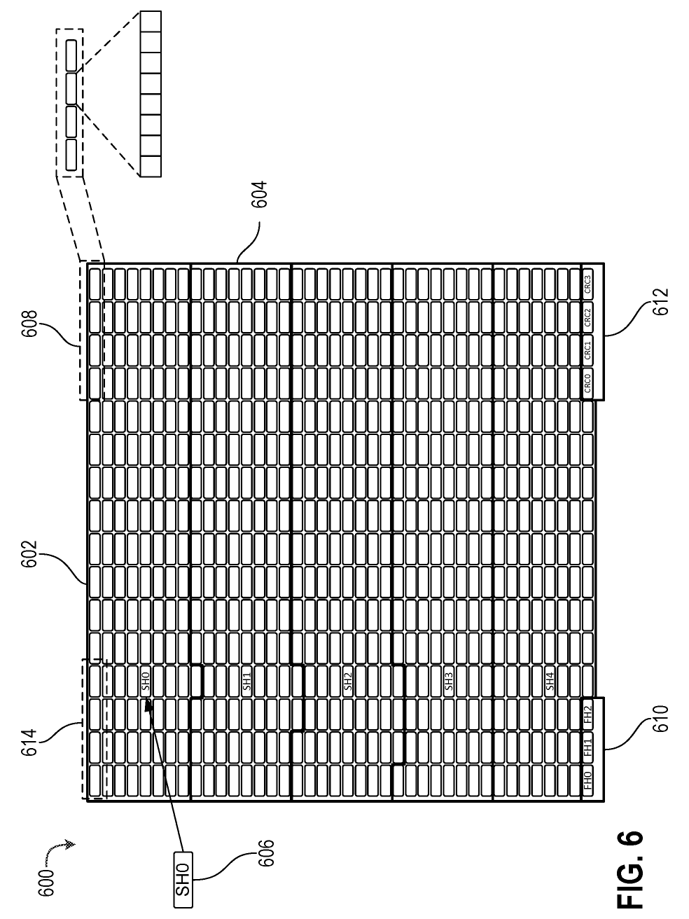

FIG. 6 illustrates an exemplary datagram 600, according to some embodiments. The datagram 600 may be implemented in accordance with some techniques described herein, although other types of control data packets are possible. Datagram 600 may in some examples be a DL flit, which may be implemented with any combination of components and/or subsystems of system 100, system 200, system 300, computer system 400, and communication system 500.

The datagram 600 may be a DL flit 602. The DL flit 602 may include n number of data segments 604. Each data segment 604 of the n number of data segments 604 may include a segment header 606 (shown as SH0, SH1, SH2, SH3, and SH4) and m number of sectors 608, with each sector 608 having a predefined number of bytes. For example, each sector may include 32-bits. The segment header 606 may describe the data that starts in the data segment 604. The m number of sectors 608 may be for packing a data payload.

The DL flit 602 may also include a flit header 610 and a CRC 612 that may be included in the DL flit 602 such that one or more of the data segments 604 may include less than m number of sectors 608 for packing the data payload. The flit header 610 may indicate the type of data and sequence number to aid in link level replay, and other information. The CRC 612 may be a calculated value characterizing the contents of the DL flit 602.

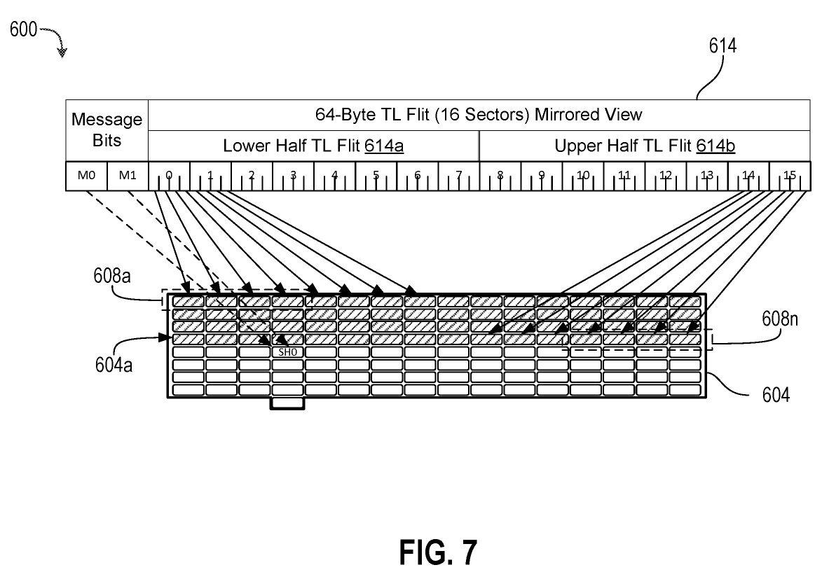

FIGS. 7-9 illustrate exemplary diagrams of portions of datagram 600 of FIG. 6 being packed with TL flits, according to some embodiments.

TL flit 614 may include 64-bytes of data. When packed into data segment 604, TL flit 614 may occupy 16-sectors (e.g., sector 608) of data segment 604 as data payload, which may be packed into DL flit 602 on a sector basis at data segment 604 based on the order the TL flits are received, and which may also depend upon when the TL flit 614 is received by the packer according to a clock frequency and a bandwidth of the data path. In some examples, data segment 604 may include up to 2 TL flits 614 packed therein, although data segment 604 may include less than two TL flits 614. TL flits 614 may be packed into DL flit 602 on the fly to reduce transmitter latency. For example, a first tick of the packer may receive a TL Flit[0] to pack and a remainder of the first half of data segment 604 may be zero filled, and a second tick of the packer may receive a TL Flit[1] available to pack, which may be packed into the corresponding sectors 608 of the second half of data segment 604 assuming that at least one sector 608 is available.

A TL flit 614 may be packed into a given data segment 604 provided the data segment 604 includes at least one unallocated sector 608. Otherwise, if the given data segment 604 does not include at least one unallocated sector 608, the TL flit 614 may be packed into a next segment 604. In addition, if an entire TL flit 614 does not pack into a single data segment 604, a remainder of the TL flit 614 may be carried over to a next segment 604. Responsive to a TL flit 614 being packed into a given data segment 604, the respective SH 606 associated with the given data segment 604 may be encoded with a value characterizing the presence of the TL flit 614. For example, the SH 606 may include at least a first message value characterizing the presence of a first TL flit message, a first TL flit value characterizing a presence of the first TL flit 614 in the given segment 604, a second message value characterizing the presence of a second TL flit message, and a second TL flit value characterizing the presence of the second TL flit 614 in the given segment 604. The SH 606 may also default to certain respective values at these locations characterizing when a given data segment 604 does not include a TL flit 614.

Referring to FIG. 7, in some examples, TL flit 614 is depicted in mirrored view, and the lower half 614a of TL flit 614 may be packed into the corresponding first half 604a of segment 604 starting at the first sector 608a because data segment 604 does not include an alternative DL sector, and the upper half 614b of TL flit 614 may be packed into the last sector 608n of the corresponding half segment 604a of data segment 604.

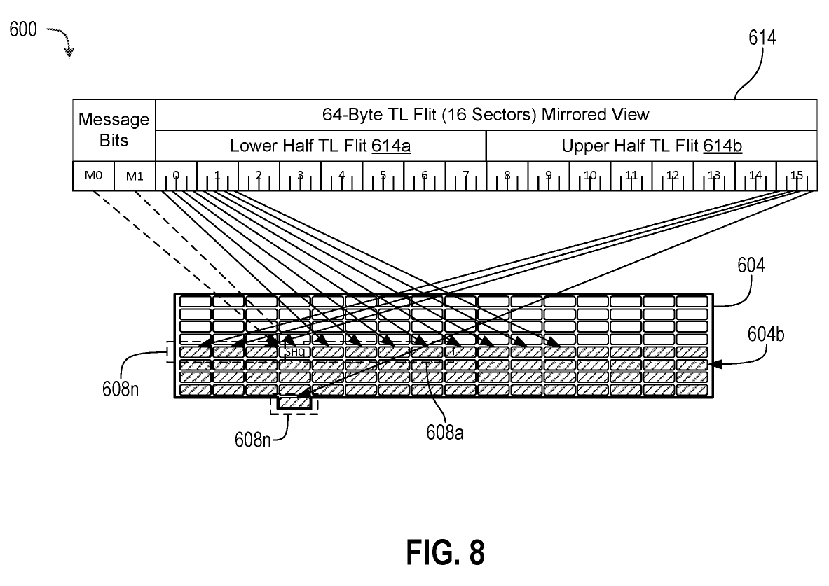

Referring to FIG. 8, in some examples, TL flit 614 is also depicted in mirrored view, and the lower half 614a of TL flit 614 may be packed into the corresponding second half 604b of segment 604 starting at the first sector 608a because data segment 604 does not include an alternative DL sector, and the upper half 614b of TL flit 614 may be packed into the last sector 608n of the corresponding half segment 604a of data segment 604.

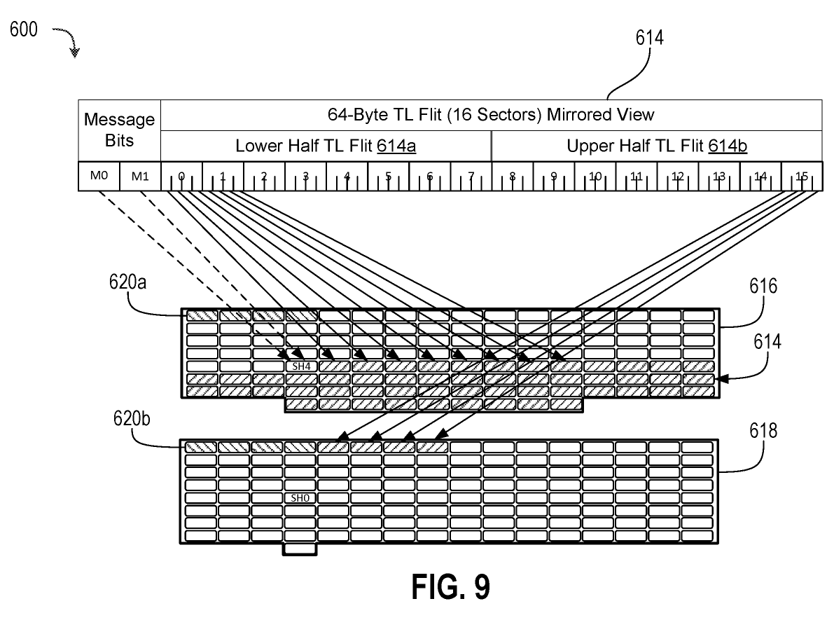

Referring to FIG. 9, the first half of data segment 616 may be filled with a previous TL Flit carry over from a previous data segment 604 and an alternative sector 620a, and TL Flit 614 received by the first tick of the packer may be added to the data segment 616 starting at the first available sector. TL flit 614 is shown packed into data segment 616 of DL flit 602 and packed on the fly into the subsequent sectors 608 and carried over into the next data segment 618, which also include data at the alternative data sector 620b, and thereby the packing of TL flit 614 at next data segment 618 starts at the next available sector. The respective segment header (SH4) associated with data segment 616 being encoded to show the mapping, and the TL flit may be designated as TL Flit[0] at the respective segment header 606.

In some examples, the data path may be a 512-bit (64-byte) data path, and a DL Flit may be packed every 10 clock ticks (e.g., 2 TL flits per segment of DL flit). In some examples, DL flits may include DL overhead of 12 bytes (and DL messages), such that TL Flits cannot be continuously packed every 2 ticks. It should be appreciated that other data widths may be possible, and that the packer may demonstrate similar packing behavior for these other data widths.

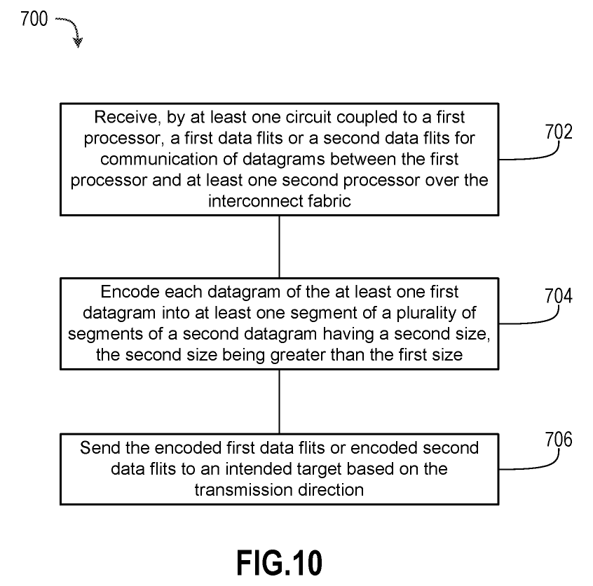

FIG. 10 illustrates a flow diagram of a method 700 for encoding datagrams for transmission between host processing devices, according to some embodiments. The method 700 may be implemented in accordance with the techniques described herein, although others are possible. Method 700 may in some examples be implemented with any combination of components and/or subsystems of system 100, system 200, system 300, computer system 400, communication system 500, and datagram 600.

At 702, the method 700 may include receiving, by at least one circuit coupled to a first processor, a first data flits or a second data flits for communication of datagrams between the first processor and at least one second processor over the interconnect fabric. The at least one circuit may in some examples include any combination of hardware, software, or firmware for receiving a data stream including the first data flits and converting them to the second data flits for transmission between from the first processor and at least one second processor over an interconnect fabric or link of the interconnect fabric. In some embodiments, the first data flit is a 64-Byte flit, and the second data flit is a 640-Byte flit.

At 704, method 700 may include encoding, by the at least one circuit coupled to a first processor, the first data flits or the second data flits into the other of the first data flits and the second data flits. Each first data flit may be packed into a first available segment of the second data flit. In some embodiments, the encoding may include packaging, in a transmit direction, the first data flits into one or more second data flits for transmission to at least one second processor over the interconnect fabric. In some embodiments, the encoding may include packaging, in a receive direction, the second data flit into one or more first data flits for transmission to the first processor.

At 706, the method 700 may include sending the encoded first data flits or encoded second data flits to an intended target based on the transmission direction.

In some embodiments, the second data flit includes a flit header characterizing a type of the second data flit, a cyclic redundancy check (CRC) characterizing a content of the second data flit, and a plurality of segments, each segment including a segment header defining a starting content of the respective each segment, an integer number of sectors based on positions of the header and the CRC, a first portion, and a second portion. In some embodiments, the first portion and the second portion each can be sized to accommodate a first data flit. Due to overhead of the second data flit, the first data flit may not fit perfectly into the respective portion of each respective segment. Accordingly, in some embodiments, the first data flit may flow from one segment to a next available segment in the second data flit.

In some embodiments, the method 700 may further include packing, by the at least one circuit coupled to the first processor, at least a portion of the first data flits into at least one of the first portion and the second portion of the respective each segment, and encoding, by the at least one circuit coupled to the first processor, data characterizing the presence of a respective first data flit and message data associated with the respective first data flit in each of the respective first portion and second portion of each segment header.

In some embodiments, each segment further comprising an alternative sector, and the segment header comprising data characterizing the presence of data messages for transmission from the at least one first circuit of the first processor to the at least one second circuit of the at least one second processor. In some embodiments, responsive to the segment header indicating the presence of the data messages for the alternate sector, the method 700 may further include encoding, by the at least one circuit coupled to the first processor, the data messages for at least one circuit of the at least one second processor into a first sector of the integer number of sectors.

In some embodiments, an apparatus includes at least one circuit of a first processor. In some embodiments, in a transmit direction, the at least one circuit receives a first data flits and packages the data of the first data flits into one or more second data flits for transmission to at least one second processor over an interconnect link. In some embodiments, in a receive direction, the at least one circuit receives a second data flit and packages the data into one or more first data flits for transmission to the first processor.

In some embodiments, the first data flit is a 64-Byte flit. In some embodiments, the second data flit is a 640-Byte flit.

In some embodiments, the second data flit includes a flit header characterizing a type of the second data flit, a cyclic redundancy check (CRC) characterizing a content of the second data flit, and a plurality of segments, each segment including a segment header defining a starting content of the respective each segment, an integer number of sectors based on positions of the header and the CRC, and a data payload. In some embodiments, the at least one circuit packs the data payload of at least a portion of the first data flits into the respective each segment.

In some embodiments, each segment header characterizes the presence of the start of a first data flit and message data associated with the first data flit.

In some embodiments, each segment includes a first portion and a second portion, the first portion and the second portion each sized to accommodate a first data flit. In some embodiments, the at least one circuit packs at least a portion of the first data flit into at least one of the first portion and the second portion of the respective each segment.

In some embodiments, the at least one circuit packs the first portion of the respective each segment at a first tick of a clock cycle, and packs the second portion of the respective each segment at a second tick of the clock cycle.

In some embodiments, each segment header further characterizes the presence of the start of the first data flit and message data associated with the first data flit in each of the respective first portion and second portion.

In some embodiments, each segment further includes an alternative sector. In some embodiments, the at least one circuit packs data messages for at least one circuit of the at least one second processor over the interconnect link. In some embodiments, responsive to the alternate sector indicating the presence of the data messages for the at least one circuit of the at least one second processor, the at least one circuit packs the data messages into a first sector of the integer number of sectors.

In some embodiments, a system includes a first processor coupled to a first circuit and at least one second processor coupled to a respective second circuit. In some embodiments, the first processor is in communicable connection to the at least one second processor over an interconnect fabric. In some embodiments, in a transmit direction, the first circuit receives a first data flits and packages the first data flits into at least one second data flit for transmission to the at least one second processor over the interconnect fabric. In some embodiments, in a receive direction, the first circuit receives a second data flit from the at least one second processor and packages the data into one or more first data flits for transmission to the first processor.

In some embodiments, the first data flit is a 64-Byte flit. In some embodiments, the second data flit is a 640-Byte flit.

In some embodiments, the second data flit includes a flit header characterizing a type of the second data flit, a cyclic redundancy check (CRC) characterizing a content of the second data flit, and a plurality of segments, each segment including a segment header defining a starting content of the respective each segment, an integer number of sectors based on positions of the header and the CRC, a first portion, and a second portion, the first portion and the second portion each being sized to accommodate a first data flit, and the at least one circuit packs at least a portion of the first data flit into at least one of the first portion and the second portion of the respective each segment.

In some embodiments, each segment header characterizes the presence of the start of a first data flit and message data associated with the first data flit.

In some embodiments, the at least one circuit packs the first portion of the respective each segment at a first tick of a clock cycle, and packs the second portion of the respective each segment at a second tick of the clock cycle.

In some embodiments, each segment header further characterizes the presence of the first data flit and message data associated with the first data flit in each of the respective first portion and second portion.

In some embodiments, each segment further includes an alternative sector. In some embodiments, the at least one circuit packs data messages for at least one circuit of the at least one second processor over the interconnect link. In some embodiments, responsive to the alternate sector indicating the presence of the data messages for the at least one circuit of the at least one second processor, the at least one circuit packs the data messages into a first sector of the integer number of sectors.

In some embodiments, a method includes receiving, by at least one circuit coupled to a first processor, a first data flits or a second data flits for communication of datagrams between the first processor and at least one second processor over the interconnect fabric, and encoding, by the at least one circuit coupled to a first processor, the first data flits or the second data flits into the other of the first data flits and the second data flits, and sending the encoded first data flits or encoded second data flits to an intended target based on the transmission direction. in some embodiments, the encoding includes packaging, in a transmit direction, the first data flits into one or more second data flits for transmission to at least one second processor over the interconnect fabric, and packaging, in a receive direction, the second data flit into one or more first data flits for transmission to the first processor.

In some embodiments, the first data flit is a 64-Byte flit. In some embodiments, the second data flit is a 640-Byte flit.

In some embodiments, the second data flit includes a flit header characterizing a type of the second data flit, a cyclic redundancy check (CRC) characterizing a content of the second data flit, and a plurality of segments, each segment including a segment header defining a starting content of the respective each segment, an integer number of sectors based on positions of the header and the CRC, a first portion, and a second portion, the first portion and the second portion each being sized to accommodate a first data flit.

In some embodiments, the method further includes packing, by the at least one circuit coupled to the first processor, at least a portion of the first data flits into at least one of the first portion and the second portion of the respective each segment, and encoding, by the at least one circuit coupled to the first processor, data characterizing the presence of a respective first data flit and message data associated with the respective first data flit in each of the respective first portion and second portion of each segment header.

In some embodiments, each segment further includes an alternative sector, and the segment header includes data characterizing the presence of data messages for transmission from the at least one first circuit of the first processor to the at least one second circuit of the at least one second processor. In some embodiments, responsive to the segment header indicating the presence of the data messages for the alternate sector, the method further includes encoding, by the at least one circuit coupled to the first processor, the data messages for at least one circuit of the at least one second processor into a first sector of the integer number of sectors.

Techniques operating according to the principles described herein can be implemented in any suitable manner. While the foregoing disclosure sets forth some examples using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts in accordance with the techniques described herein. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein does not depict the syntax or operation of any particular circuit or of any particular programming language or type of programming language. Rather, the flowchart(s) illustrates the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including application software, system software, firmware, middleware, embedded code, or any other suitable type of software. Such computer-executable instructions can be written using any of a number of suitable programming languages and/or programming or scripting tools and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described are merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including system memory, accelerator memory, and/or system memory of the computer system 400 of FIG. 4 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within + 20%, + 10%, or + 5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. An apparatus comprising:
at least one circuit of a first processor,
wherein, in a transmit direction, the at least one circuit receives a first data flits and packages the data of the first data flits into one or more second data flits for transmission to at least one second processor over an interconnect link,
wherein, in a receive direction, the at least one circuit receives a second data flit and packages the data into one or more first data flits for transmission to the first processor.

2. The apparatus according to claim 1, wherein the first data flit is a 64-Byte flit, and
wherein the second data flit is a 640-Byte flit.

3. The apparatus according to claim 2, wherein the second data flit comprising:
a flit header characterizing a type of the second data flit,
a cyclic redundancy check (CRC) characterizing a content of the second data flit, and
a plurality of segments, each segment comprising:
a segment header defining a starting content of the respective each segment,
an integer number of sectors based on positions of the header and the CRC, and
a data payload,
wherein the at least one circuit packs the data payload of at least a portion of the first data flits into the respective each segment.

4. The apparatus according to claim 3, wherein each segment header characterizing the presence of the start of a first data flit and message data associated with the first data flit.

5. The apparatus according to claim 3, wherein each segment comprising a first portion and a second portion, the first portion and the second portion each sized to accommodate a first data flit, and
wherein the at least one circuit packs at least a portion of the first data flit into at least one of the first portion and the second portion of the respective each segment.

6. The apparatus according to claim 3, wherein the at least one circuit packs the first portion of the respective each segment at a first tick of a clock cycle, and packs the second portion of the respective each segment at a second tick of the clock cycle.

7. The apparatus according to claim 5, wherein each segment header further characterizing the presence of the start of the first data flit and message data associated with the first data flit in each of the respective first portion and second portion.

8. The apparatus according to claim 3, wherein each segment further comprising:
an alternative sector,
wherein the at least one circuit packs data messages for at least one circuit of the at least one second processor over the interconnect link,
wherein, responsive to the alternate sector indicating the presence of the data messages for the at least one circuit of the at least one second processor, the at least one circuit packs the data messages into a first sector of the integer number of sectors.

9. A system comprising:
a first processor coupled to a first circuit; and
at least one second processor coupled to a respective second circuit,
wherein the first processor is in communicable connection to the at least one second processor over an interconnect fabric,
wherein, in a transmit direction, the first circuit receives a first data flits and packages the first data flits into at least one second data flit for transmission to the at least one second processor over the interconnect fabric, and
wherein, in a receive direction, the first circuit receives a second data flit from the at least one second processor and packages the data into one or more first data flits for transmission to the first processor.

10. The system according to claim 9, wherein the first data flit is a 64-Byte flit, and
wherein the second data flit is a 640-Byte flit.

11. The system according to claim 10, wherein the second data flit comprising:
a flit header characterizing a type of the second data flit,
a cyclic redundancy check (CRC) characterizing a content of the second data flit, and
a plurality of segments, each segment comprising:
a segment header defining a starting content of the respective each segment,
an integer number of sectors based on positions of the header and the CRC,
a first portion, and
a second portion,
wherein the first portion and the second portion each being sized to accommodate a first data flit, and
wherein the first circuit packs at least a portion of the first data flit into at least one of the first portion and the second portion of the respective each segment.

12. The system according to claim 11, wherein each segment header characterizing the presence of the start of a first data flit and message data associated with the first data flit.

13. The system according to claim 11, wherein the first circuit packs the first portion of the respective each segment at a first tick of a clock cycle, and packs the second portion of the respective each segment at a second tick of the clock cycle.

14. The system according to claim 11, wherein each segment header further characterizing the presence of the first data flit and message data associated with the first data flit in each of the respective first portion and second portion.

15. The system according to claim 11, wherein each segment further comprising:
an alternative sector,
wherein the first circuit packs data messages for the respective second circuit of the at least one second processor over the interconnect fabric,
wherein, responsive to the alternate sector indicating the presence of the data messages for the at least one circuit of the at least one second processor, the at least one circuit packs the data messages into a first sector of the integer number of sectors.

16. A method comprising:
receiving, by at least one circuit coupled to a first processor, a first data flits or a second data flits for communication of datagrams between the first processor and at least one second processor over an interconnect fabric; and
encoding, by the at least one circuit coupled to a first processor, the first data flits or the second data flits into the other of the first data flits and the second data flits and sending the encoded first data flits or encoded second data flits to an intended target based on a transmission direction, wherein the encoding comprising:
packaging, in a transmit direction, the first data flits into one or more second data flits for transmission to the at least one second processor over the interconnect fabric, and
packaging, in a receive direction, the second data flit into one or more first data flits for transmission to the first processor.

17. The method according to claim 16, wherein the first data flit is a 64-Byte flit, and
wherein the second data flit is a 640-Byte flit.

18. The method according to claim 16, wherein the second data flit comprising a flit header characterizing a type of the second data flit, a cyclic redundancy check (CRC) characterizing a content of the second data flit, and a plurality of segments, each segment comprising a segment header defining a starting content of the respective each segment, an integer number of sectors based on positions of the header and the CRC, a first portion, and a second portion,
wherein the first portion and the second portion each being sized to accommodate a first data flit.

19. The method according to claim 18, wherein the method further comprising:
packing, by the at least one circuit coupled to the first processor, at least a portion of the first data flits into at least one of the first portion and the second portion of the respective each segment; and
encoding, by the at least one circuit coupled to the first processor, data characterizing the presence of a respective first data flit and message data associated with the respective first data flit in each of the respective first portion and second portion of each segment header.

20. The method according to claim 18, wherein each segment further comprising an alternative sector, and the segment header comprising data characterizing the presence of data messages for transmission from the at least one first circuit of the first processor to at least one second circuit of the at least one second processor, and
wherein, responsive to the segment header indicating the presence of the data messages for the alternate sector, the method further comprising:
encoding, by the at least one circuit coupled to the first processor, the data messages for at least one circuit of the at least one second processor into a first sector of the integer number of sectors.
